(19) United States
(12) Patent Application Publication
(10) Pub. No.: US 2014/0095077 A1
(43) Pub. Date: Apr. 3, 2014

(54) SYSTEM AND METHOD FOR WEATHER SATELLITE INFORMATION PROCESSING ALGORITHM SIMULATION

(71) Applicant: ELECTRONICS AND TELECOMMUNICATIONS RESEARCH INSTITUTE, Daejeon (KR)

(72) Inventors: Won Chan JUNG, Daejeon (KR); Do Seob AHN, Daejeon (KR)

(73) Assignee: ELECTRONICS AND TELECOMMUNICATIONS RESEARCH INSTITUTE, Daejeon (KR)

(21) Appl. No.: 14/039,864

(22) Filed: Sep. 27, 2013

(30) Foreign Application Priority Data
Sep. 28, 2012 (KR) 10-2012-0108468

(51) Int. Cl. G01W 1/10

(52) U.S. Cl. CPC G01W 1/10
USPC 702/3

(57) ABSTRACT

A weather satellite information processing algorithm simulation system and method are provided. The weather satellite information processing algorithm simulation system may include a data supplying unit to supply input data that is required to operate a weather satellite information processing algorithm, an algorithm operator to operate the weather satellite information processing algorithm, using the supplied input data, and a result analyzer to analyze a result obtained by operating the weather satellite information processing algorithm, and to generate analysis result data. The weather satellite information processing to algorithm may extract a product from weather satellite information stored by a weather satellite earth station.

### CROSS-REFERENCE TO RELATED APPLICATION

This application claims the benefit of Korean Patent Application No. 10-2012-0108468, filed on Sep. 28, 2012, in the Korean Intellectual Property Office, the disclosure of which is incorporated herein by reference.

### BACKGROUND

1. Field of the Invention

The present invention relates to a technical aspect to verify a developed algorithm when a payload is being developed or is loaded in a satellite in the sky, through a simulator system that copies a portion of the payload that is linked to a portion of an algorithm within an earth station.

2. Description of the Related Art

Since all satellites generally measure atmospheric phenomena, satellites may be referred to as “meteorological satellites” or “weather satellites.” However, clearly, satellites refer to only satellites designed and launched only for weather observation.

Weather satellites may recognize an exact location, a size and the like of electric wires, low pressure, and the like that are required for a short-range forecast, may observe a radiant energy radiated from the earth to outer space, an amount of rays of the sun to be reflected from the earth and atmosphere, a solar energy outside the atmosphere, and the like, and may transmit observed weather satellite information to a weather satellite earth station.

An algorithm used to process weather satellite information measured by a satellite and transmitted to the ground may be mounted in a weather satellite earth station, and may function to extract required information from source data.

For example, when a new payload is loaded in a weather satellite, a processing algorithm and a payload may be developed in the same period. Accordingly, it may be difficult to receive actual data from the payload, and to measure an operation accuracy of the algorithm.

Additionally, when an weather satellite information processing algorithm is to be modified, or when a new algorithm is to be mounted in an earth station, after a payload is loaded in a satellite and launched, it is difficult to perform a test of linking with the payload.

### SUMMARY

According to an aspect of the present invention, there is provided a weather satellite information processing algorithm simulation system including: a data supplying unit to supply input data that is required to operate a weather satellite information processing algorithm; an algorithm operator to operate the weather satellite information processing algorithm, using the supplied input data; and a result analyzer to analyze a result obtained by operating the weather satellite information processing algorithm, and to generate analysis result data. The weather satellite information processing algorithm may extract a product from weather satellite information stored by a weather satellite earth station.

The weather satellite information processing algorithm simulation system may further include a database to store the input data obtained by the weather satellite earth station receiving source weather data via an antenna from a satellite, and performing at least one of decomposing, bolometric correction and geometric correction on the received source weather data.

The result analyzer may compare and analyze a new product and a pre-stored product, based on the generated analysis result data.

The result analyzer may determine whether the weather satellite information processing algorithm is to be applied to the weather satellite earth station, based on a result of the comparing and analyzing.

According to another aspect of the present invention, there is provided a weather satellite system including: a weather satellite information processing algorithm simulator to operate a weather satellite information processing algorithm with respect to input data, and to determine whether the weather satellite information processing algorithm is to be applied to the weather satellite system; and a weather satellite earth station to receive source data from a payload of a weather satellite based on the weather satellite information processing algorithm, and to output required data, when the weather satellite information processing algorithm is determined to be applicable to the weather satellite system.

The weather satellite information processing algorithm simulator may operate the weather satellite information processing algorithm, may compare and analyze a pre-stored product and a new product generated from the input data, and may determine whether the weather satellite information processing algorithm is to be applied to the weather satellite system.

The weather satellite information processing algorithm simulator may determine whether the weather satellite information processing algorithm is to be applied to the weather satellite earth station, based on a result of the comparing and analyzing.

The weather satellite earth station may include a weather satellite information receiver to receive source weather data from a satellite, and to decompose the received source weather data, a weather satellite information preprocessor to preprocess the decomposed source weather data, and to store the preprocessed source weather data in a database, and a weather satellite information processor to apply the weather satellite information processing algorithm to the preprocessed source weather data, and to extract a product.

The weather satellite earth station may further include a weather satellite information analyzer to add required information to the extracted product, and to produce general purpose information that is available by users.

The weather satellite earth station may further include a weather satellite information service unit to provide the users with the produced general purpose information.

According to another aspect of the present invention, there is provided a weather satellite information processing algorithm simulation method including: supplying, by a data supplying unit, input data that is required to operate a weather satellite information processing algorithm; operating, by an algorithm operator, the weather satellite information processing algorithm, using the supplied input data; and analyzing, by a result analyzer, a result obtained by operating the weather satellite information processing algorithm, and generating analysis result data. The weather satellite information processing algorithm may extract a product from weather satellite information stored by a weather satellite earth station.

The weather satellite information processing algorithm simulation method may further include storing, by a database, the input data obtained by the weather satellite earth station receiving source weather data via an antenna from a satellite, and performing at least one of decomposing, bolometric correction and geometric correction on the received source weather data.

The analyzing the result and generating the analysis result data may include comparing and analyzing a new product and a pre-stored product, based on the generated analysis result data, and determining whether the weather satellite information processing algorithm is to be applied to the weather satellite earth station, based on a result of the comparing and analyzing.

According to another aspect of the present invention, there is provided an operation method of a weather satellite system, including: operating, by a weather satellite information processing algorithm simulator, a weather satellite information processing algorithm with respect to input data and determining whether the weather satellite information processing algorithm is to be applied to the weather satellite system; and receiving, by a weather satellite earth station, source data from a payload of a weather satellite based on the weather satellite information processing algorithm, and outputting required data, when the weather satellite information processing algorithm is determined to be applicable to the weather satellite system.

The operating the weather satellite information processing algorithm and determining whether the weather satellite information processing algorithm is to be applied to the weather satellite system, may include operating the weather satellite information processing algorithm, and comparing and analyzing a pre-stored product and a new product generated from the input data, and determining whether the weather satellite information processing algorithm is to be applied to the weather satellite earth station, based on a result of the comparing and analyzing.

The receiving the source data from the payload and outputting the required data may include receiving, by a weather satellite information receiver, source weather data from a satellite, and decomposing the received source weather data, preprocessing, by a weather satellite information preprocessor, the decomposed source weather data, and storing the preprocessed source weather data in a database, and applying, by a weather satellite information processor, the weather satellite information processing algorithm to the preprocessed source weather data, and extracting a product.

The receiving the source data from the payload and outputting the required data may further include adding, by a weather satellite information analyzer, required information to the extracted product, and producing general purpose information that is available by users.

The receiving the source data from the payload and outputting the required data may further include providing, by a weather satellite information service unit, the users with the produced general purpose information.

### Effect

According to embodiments of the present invention, through a system and method for a simulation associated with a portion of a weather satellite payload that is linked to an algorithm in a weather satellite earth station, it is possible to verily a weather information processing algorithm in a situation in which the weather satellite payload does not exist.

Additionally, according to embodiments of the present invention, it is possible to prevent an unexpected accident that may have an influence on an earth station system, by verifying, in advance, a new algorithm before the new algorithm is mounted in an earth station.

Furthermore, according to embodiments of the present invention, it is possible to minimize an influence on management of an earth station, since a corresponding algorithm may be sufficiently verified, and an algorithm of the earth station may be changed.

Moreover, according to embodiments of the present invention, it is possible to determine whether an earth station system is abnormally operated, by comparing a result obtained by performing an algorithm before the algorithm is mounted in an earth station, with a result obtained by performing the algorithm after the algorithm is mounted in the earth station, since the earth station system includes the result obtained by performing the algorithm before the algorithm is mounted in the earth station.

### BRIEF DESCRIPTION OF THE DRAWINGS

These and/or other aspects, features, and advantages of the invention will become apparent and more readily appreciated from the following description of exemplary embodiments, taken in conjunction with the accompanying drawings of which:

FIG. 1 is a diagram illustrating a weather satellite system configured to verify a weather satellite information processing algorithm using a weather satellite information processing algorithm simulation system according to an embodiment of the present invention:

FIG. 2 is a diagram illustrating a weather satellite earth station according to an embodiment of the present invention;

FIG. 3 is a diagram illustrating an operation of a weather satellite information processing algorithm of a weather satellite information processor of FIG. 2:

FIG. 4 is a diagram illustrating a weather satellite information processing algorithm simulation system according to an embodiment of the present invention;

FIG. 5 is a flowchart illustrating an operation method of a weather satellite system according to an embodiment of the present invention; and

FIG. 6 is a flowchart illustrating a weather satellite information processing algorithm simulation method according to an embodiment of the present invention.

### DETAILED DESCRIPTION

Reference will now be made in detail to exemplary embodiments of the present invention, examples of which are illustrated in the accompanying drawings, wherein like reference numerals refer to the like elements throughout. Exemplary embodiments are described below to explain the present invention by referring to the figures.

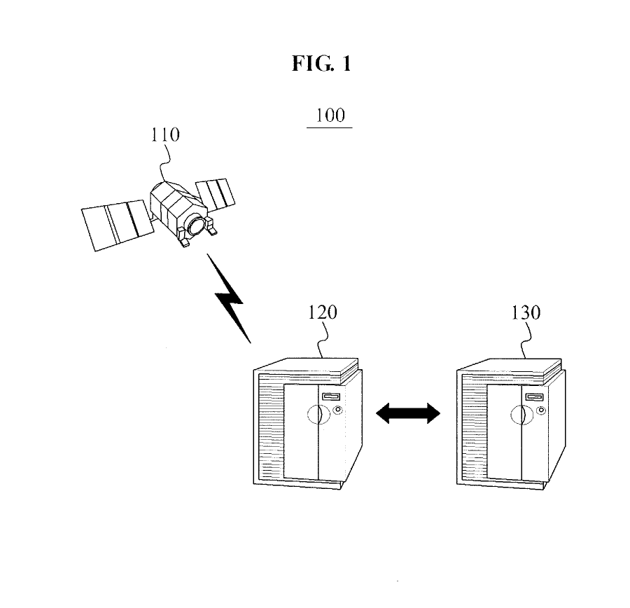

FIG. 1 is a diagram illustrating a weather satellite system 100 configured to verify a weather satellite information processing algorithm using a weather satellite information processing algorithm simulation system according to an embodiment of the present invention.

When a payload is being developed or is loaded in a satellite in the sky, the weather satellite system 100 may verify a newly developed algorithm, using a simulator that copies a portion of the payload that is linked to a portion of an algorithm within an earth station.

Accordingly, the weather satellite system 100 may include a weather satellite information processing algorithm simulator 120, and a weather satellite earth station 130.

The weather satellite information processing algorithm simulator 120 may operate the weather satellite information processing algorithm with respect to input data, and may determine whether the weather satellite information processing algorithm is to be applied to the weather satellite system 100.

When a payload is being developed or is loaded in a satellite in the sky, the weather satellite information processing algorithm simulator 120 may verify a developed algorithm, and may determine whether the algorithm is to be applied to the weather satellite system 100.

For example, the weather satellite information processing algorithm simulator 120 may operate the weather satellite information processing algorithm, may compare and analyze a pre-stored product and a new product generated from the input data, and may determine whether the weather satellite information processing algorithm is to be applied to the weather satellite system 100.

As a result of the comparing and analyzing, the weather satellite information processing algorithm simulator 120 may determine whether the weather satellite information processing algorithm is to be applied to the weather satellite earth station 130.

When the weather satellite information processing algorithm is determined to be applicable to the weather satellite system 100, the weather satellite earth station 130 may receive source data from a payload of a weather satellite based on the weather satellite information processing algorithm, and may output required data.

The weather satellite earth station 130 may add required information to the received source data, may produce information that may be used by users, and may store the produced information in a database.

Additionally, the weather satellite earth station 130 may provide users with information, using various schemes. The information may be processed and analyzed, and may be stored in the database.

As described above, by using the weather satellite system 100, the weather satellite information processing algorithm may be verified in a situation in which a weather satellite payload does not exist, through a system and method for a simulation associated with a portion of the weather satellite payload that is linked to an algorithm in a weather satellite earth station.

Additionally, by using the weather satellite system 100, a new algorithm may be verified in advance, before the new algorithm is mounted in an earth station. Thus, it is possible to prevent an unexpected accident that may have an influence on an earth station system.

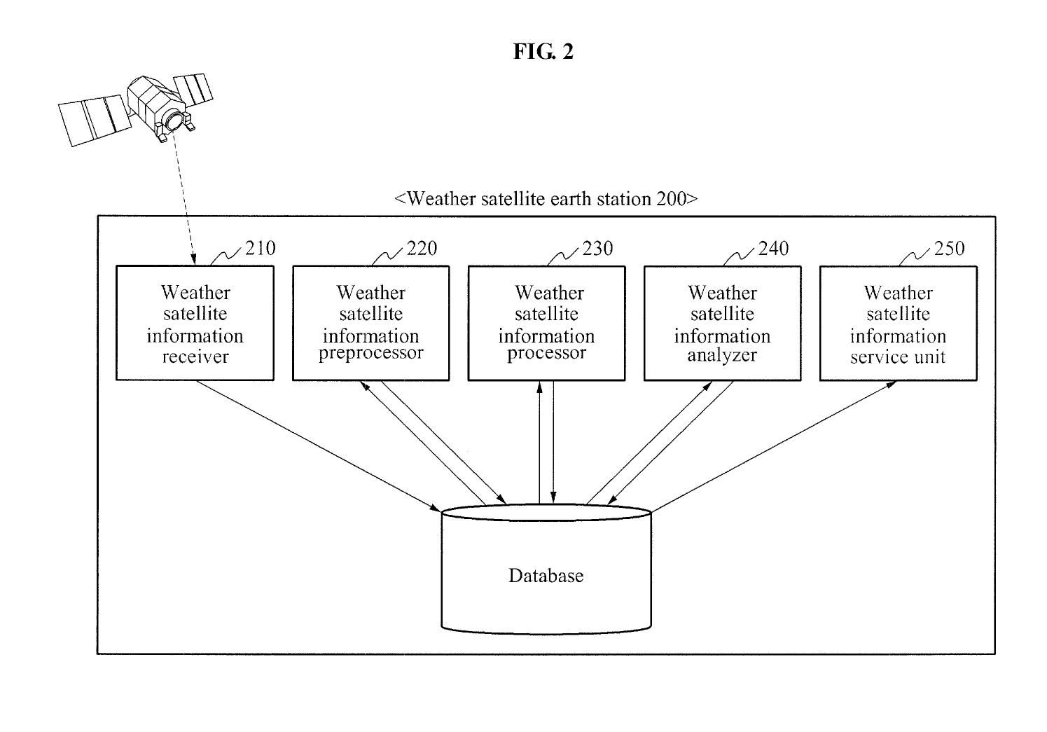

FIG. 2 is a diagram illustrating a weather satellite earth station 200 according to an embodiment of the present invention.

The weather satellite earth station 200 of FIG. 2 may include a weather satellite information receiver 210, a weather satellite information preprocessor 220, and a weather satellite information processor 230.

The weather satellite information receiver 210 may receive source weather data from a satellite, and may decompose the received source weather data.

Specifically, the weather satellite information receiver 210 may receive source weather data from a weather satellite via an antenna, may decompose the received source weather data, and may store, in a database, the decomposed source weather data as data with level “0.”

The weather satellite information preprocessor 220 may preprocess the decomposed source weather data, and may store the preprocessed source weather data in the database.

The weather satellite information preprocessor 220 may perform bolometric correction and geometric correction on information stored by the weather satellite information receiver 210, and may store, in the database, the information as data with level “1B.”

The weather satellite information processor 230 may apply the Weather satellite information processing algorithm to the preprocessed source weather data, and may extract a product.

Additionally, the weather satellite information processor 230 ma, apply each algorithm to stored information, may extract a product, and may store, in the database, the product as data with level “2.”

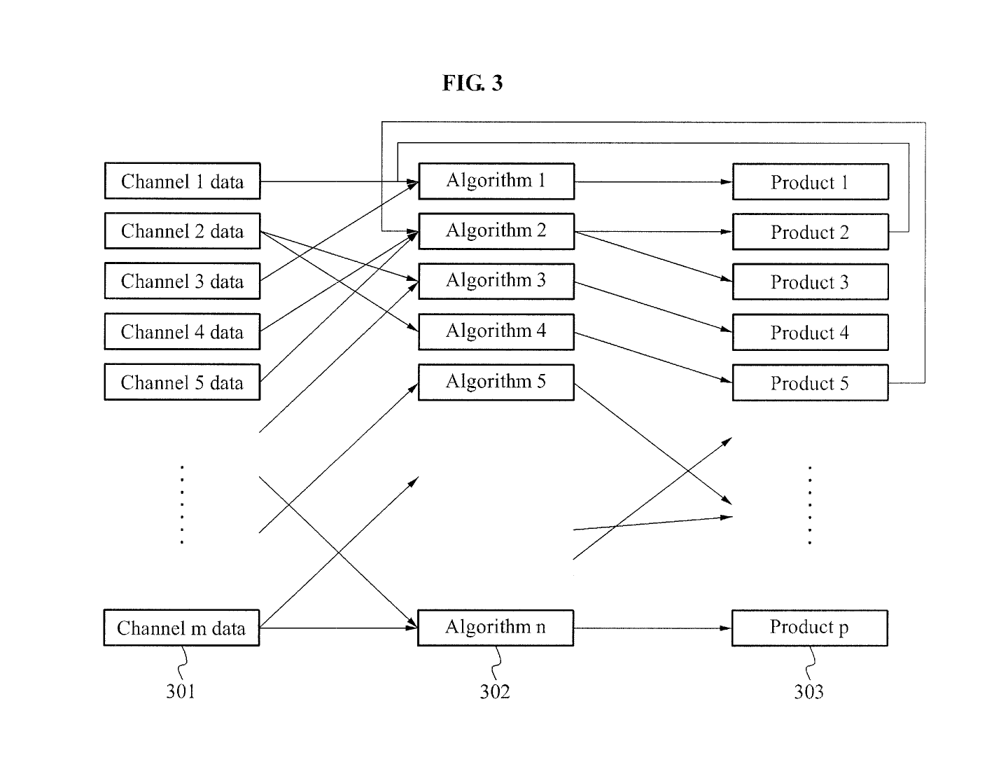

FIG. 3 is a diagram illustrating an operation of a weather satellite information processing algorithm of the weather satellite information processor 230 of FIG. 2.

When channel 1 data through channel m data 301, that is, level 1B information measured in “m” channels are input to an algorithm 1 through an algorithm n 302, each of the algorithms 1 through n 302 may be executed by reading data of a channel required to operate the algorithms, and may produce products 1 through p 303.

A single algorithm may produce at least two products based on a characteristic of an algorithm. Additionally, a product produced in advance may be used as input data of an algorithm.

Referring back to FIG. 2, the weather satellite earth station 200 may further include a weather satellite information analyzer 240.

The weather satellite information analyzer 240 may add required information to information stored by the weather satellite information processor 230, may produce information that may be used by users, and may store, in the database, the produced information as data with level “3.”

Additionally, the weather satellite earth station 200 may further include a weather satellite information service unit 250.

The weather satellite information service unit 250 may provide information that is already processed and analyzed to a user requiring the information, by using various schemes.

The database may store all data of levels “0” to “3”, for each reception time.

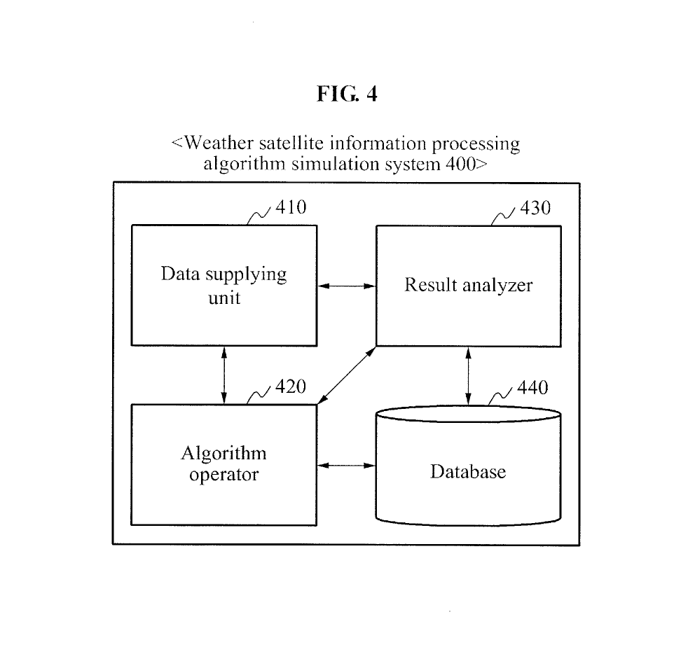

FIG. 4 is a diagram illustrating a weather satellite information processing algorithm simulation system 400 according to an embodiment of the present invention.

The weather satellite information processing algorithm simulation system 400 of FIG. 4 may include a data supplying unit 410, an algorithm operator 420, and a result analyzer 430.

The data supplying unit 410 may supply input data that is required to operate a weather satellite information processing algorithm.

The weather satellite information processing algorithm may extract a product from weather satellite information stored by a weather satellite earth station.

The data supplying unit 410 may read, from a database 440, input data that is required to operate a weather satellite information processing algorithm that is to be verified, and may supply the input data to the algorithm operator 420.

The algorithm operator 420 may operate the weather satellite information processing algorithm, using the supplied input data.

For example, the algorithm operator 420 may include a new weather satellite information processing algorithm. The algorithm operator 420 may receive level 1B data that is required for the new weather satellite information processing algorithm from the data supplying unit 410, may execute the new weather satellite information processing algorithm, and may transfer a result obtained by executing the new weather satellite information processing algorithm to the result analyzer 430.

The result analyzer 430 may analyze a result obtained by operating the weather satellite information processing algorithm, and may generate analysis result data.

The result analyzer 430 may compare a new product with a product stored in advance in the database 440, and may verify whether a new algorithm is properly implemented.

For example, the result analyzer 430 may compare and analyze a new product and a pre-stored product, based on the generated analysis result data.

Additionally, the result analyzer 430 may determine whether the weather satellite information processing algorithm is to be applied to the weather satellite earth station, based on a result of the comparing and analyzing.

The weather satellite information processing algorithm simulation system 400 may further include the database 440.

The database 440 may store level 1B data, and a result of a product extracted through a previous algorithm. The level 1B data may be collected until now or may include simulated information.

Specifically, the database 440 may store input data obtained by the weather satellite earth station receiving source weather data via an antenna from a satellite, and performing at least one of decomposing, bolometric correction and geometric correction on the received source weather data.

As described above, by using the weather satellite information processing algorithm simulation system 400, a weather satellite information processing algorithm may be verified in a situation in which a weather satellite payload does not exist, through a system and method for a simulation associated with a portion of the weather satellite payload that is linked to an algorithm in a weather satellite earth station.

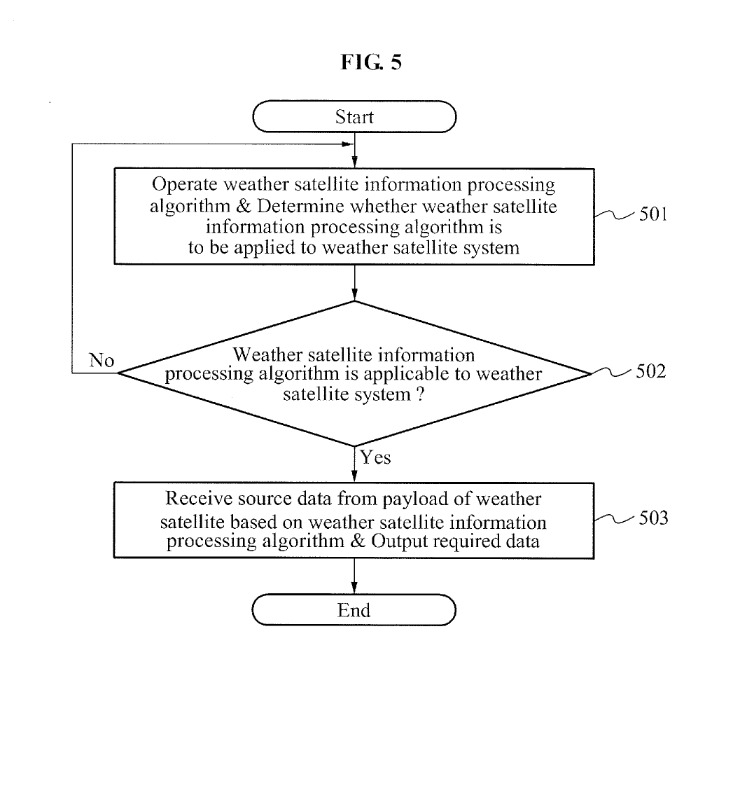

FIG. 5 is a flowchart illustrating an operation method of a weather satellite system according to an embodiment of the present invention.

Referring to FIG. 5, in operation 501, a weather satellite information processing algorithm simulator may operate a weather satellite information processing algorithm with respect to input data, and may determine whether the weather satellite information processing algorithm is to be applied to the weather satellite system.

In operation 502, based on a result of operation 501, whether the weather satellite information processing algorithm is applicable to the weather satellite system may be determined.

For example, to determine whether the weather satellite information processing algorithm is to be applied to the weather satellite system, the weather satellite information processing algorithm may be operated, and a pre-stored product and a new product generated from the input data may be compared and analyzed.

Subsequently, based on a result of the comparing and analyzing, whether the weather satellite information processing algorithm is to be applied to a weather satellite earth station may be determined.

When the weather satellite information processing algorithm is determined to be applicable to the weather satellite system in operation 502, the weather satellite information processing algorithm may be applied to the weather satellite system.

Specifically, the weather satellite information processing algorithm may be applied to the weather satellite system so that source data may be received from a payload of a to weather satellite based on the weather satellite information processing algorithm and that required data may be output in operation 503.

Accordingly, in the operation method of FIG. 5, a weather satellite information receiver may receive source weather data from a satellite, and may decompose the received source weather data. Additionally, a weather satellite information preprocessor may preprocess the decomposed source weather data, and may store the preprocessed source weather data in a database. A weather satellite information processor may apply the weather satellite information processing algorithm to the preprocessed source weather data, and may extract a product.

Therefore, the source data may be received from the payload of the weather satellite, and the required data may be output.

Additionally, in the operation method of FIG. 5, a weather satellite information analyzer may add required information to the extracted product, and may produce general purpose information that may be used by users.

Furthermore, in the operation method of FIG. 5, a weather satellite information service unit may provide the users with the produced general purpose information.

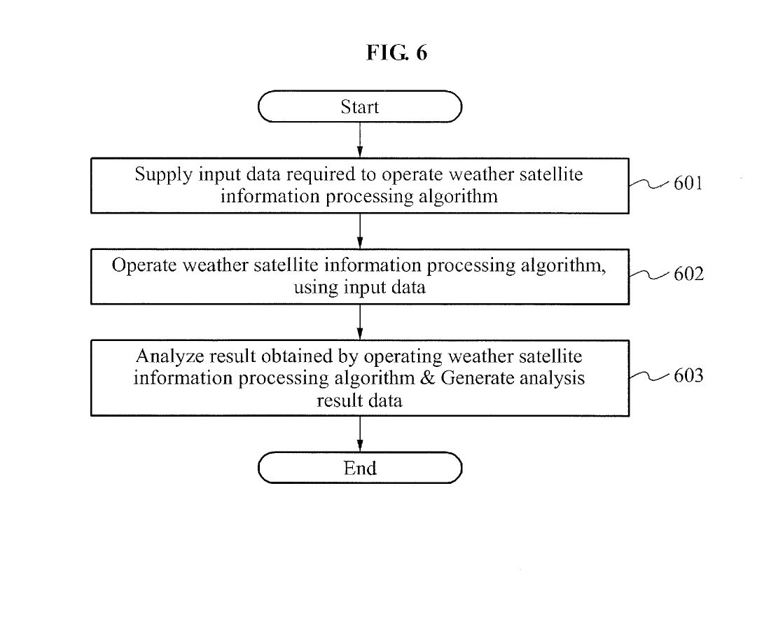

FIG. 6 is a flowchart illustrating a weather satellite information processing algorithm simulation method according to an embodiment of the present invention.

Referring to FIG. 6, in operation 601, a data supplying unit may supply input data that is required to operate a weather satellite information processing algorithm.

The weather satellite information processing algorithm may extract a product from weather satellite information stored by a weather satellite earth station.

In operation 602, an algorithm operator may operate the weather satellite information processing algorithm, using the supplied input data.

In operation 603, a result analyzer may analyze a result obtained by operating the weather satellite information processing algorithm, and may generate analysis result data.

In the weather satellite information processing algorithm simulation method of FIG. 6, a database may store input data obtained by the weather satellite earth station receiving source weather data via an antenna from a satellite, and performing at least one of decomposing, bolometric correction and geometric correction on the received source weather data.

The above-described embodiments of the present invention may be recorded in non-transitory computer-readable media including program instructions to implement various operations embodied by a computer. The media may also include, alone or in combination with the program instructions, data files, data structures, and the like. The program instructions recorded on the media may be those specially designed and constructed for the purposes of the embodiments, or they may be of the kind well-known and available to those having skill in the computer software arts. Examples of non-transitory computer-readable media include magnetic media such as hard disks, floppy disks, and magnetic tape; optical media such as CD ROM disks and DVDs; magneto-optical media such as optical discs; and hardware devices that are specially configured to store and perform program instructions, such as read-only memory (ROM), random access memory (RAM). Hash memory, and the like. Examples of program instructions include both machine code, such as produced by a compiler, and files containing higher level code that may be executed by the computer using an interpreter. The described hardware devices may be configured to act as one or more software modules in order to perform the operations of the above-described embodiments of the present invention, or vice versa.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

What is claimed is:

1. A weather satellite information processing algorithm simulation system, comprising:
a data supplying unit to supply input data that is required to operate a weather satellite information processing algorithm;
an algorithm operator to operate the weather satellite information processing algorithm, using the supplied input data; and
a result analyzer to analyze a result obtained by operating the weather satellite information processing algorithm, and to generate analysis result data,
wherein the weather satellite information processing algorithm comprises an algorithm to extract a product from weather satellite information stored by a weather satellite earth station.

2. The weather satellite information processing algorithm simulation system of claim 1, further comprising:
a database to store the input data obtained by the weather satellite earth station receiving source weather data via an antenna from a satellite, and performing at least one of decomposing, bolometric correction and geometric correction on the received source weather data.

3. The weather satellite information processing algorithm simulation system of claim 1, wherein the result analyzer compares and analyzes a new product and a pre-stored product, based on the generated analysis result data.

4. The weather satellite information processing algorithm simulation system of claim 3, wherein the result analyzer determines whether the weather satellite information processing algorithm is to be applied to the weather satellite earth station, based on a result of the comparing and analyzing.

5. A weather satellite system, comprising:
a weather satellite information processing algorithm simulator to operate a weather satellite information processing algorithm with respect to input data, and to determine whether the weather satellite information processing algorithm is to be applied to the weather satellite system; and
a weather satellite earth station to receive source data from a payload of a weather satellite based on the weather satellite information processing algorithm, and to output required data, when the weather satellite information processing algorithm is determined to be applicable to the weather satellite system.

6. The weather satellite system of claim 5, wherein the weather satellite information processing algorithm simulator operates the weather satellite information processing algorithm, compares and analyzes a pre-stored product and a new product generated from the input data, and determines whether the weather satellite information processing algorithm is to be applied to the weather satellite system.

7. The weather satellite system of claim 6, wherein the weather satellite information processing algorithm simulator determines whether the weather satellite information processing algorithm is to be applied to the weather satellite earth station, based on a result of the comparing and analyzing.

8. The weather satellite system of claim 5, wherein the weather satellite earth station comprises:
a weather satellite information receiver to receive source weather data from a satellite, and to decompose the received source weather data;
a weather satellite information preprocessor to preprocess the decomposed source weather data, and to store the preprocessed source weather data in a database; and
a weather satellite information processor to apply the weather satellite information processing algorithm to the preprocessed source weather data, and to extract a product.

9. The weather satellite system of claim 8, wherein the weather satellite earth station further comprises:
a weather satellite information analyzer to add required information to the extracted product, and to produce general purpose information that is available by users.

10. The weather satellite system of claim 8, wherein the weather satellite earth station further comprises:
a weather satellite information service unit to provide the users with the produced general purpose information.

11. A weather satellite information processing algorithm simulation method, comprising:
supplying, by a data supplying unit, input data that is required to operate a weather satellite information processing algorithm;
operating, by an algorithm operator, the weather satellite information processing algorithm, using the supplied input data; and
analyzing, by a result analyzer, a result obtained by operating the weather satellite information processing algorithm; and generating analysis result data,
wherein the weather satellite information processing algorithm comprises an algorithm to extract a product from weather satellite information stored by a weather satellite earth station.

12. The weather satellite information processing algorithm simulation method of claim 11, further comprising:
storing by a database, the input data obtained by the weather satellite earth station receiving source weather data via an antenna from a satellite, and performing at least one of decomposing, bolometric correction and geometric correction on the received source weather data.

13. The weather satellite information processing algorithm simulation method of claim 11, wherein the analyzing the result and generating the analysis result data comprises:
comparing and analyzing a new product and a pre-stored product, based on the generated analysis result data; and
determining whether the weather satellite information processing algorithm is to be applied to the weather satellite earth station, based on a result of the comparing and analyzing.

14. An operation method of a weather satellite system, the operation method comprising:
operating, by a weather satellite information processing algorithm simulator, a weather satellite information processing algorithm with respect to input data, and determining whether the weather satellite information processing algorithm is to be applied to the weather satellite system; and
receiving, by a weather satellite earth station, source data from a payload of a weather satellite based on the weather satellite information processing algorithm, and outputting required data, when the weather satellite information processing algorithm is determined to be applicable to the weather satellite system.

15. The operation method of claim 14, wherein the operating the weather satellite information processing algorithm and determining whether the weather satellite information processing algorithm is to be applied to the weather satellite system comprises:
operating the weather satellite information processing algorithm, and comparing and analyzing a pre-stored product and a new product generated from the input data; and
determining whether the weather satellite information processing algorithm is to be applied to the weather satellite earth station, based on a result of the comparing and analyzing.

16. The operation method of claim 14, wherein the receiving the source data from the payload and outputting the required data comprises:
receiving, by a weather satellite information receiver, source weather data from a satellite, and decomposing the received source weather data;
preprocessing, by a weather satellite information preprocessor, the decomposed source weather data, and storing the preprocessed source weather data in a database; and
applying, by a weather satellite information processor, the weather satellite information processing algorithm to the preprocessed source weather data, and extracting a product.

17. The operation method of claim 16, wherein the receiving the source data from the payload and outputting the required data further comprises:
adding, by a weather satellite information analyzer, required information to the extracted product, and producing general purpose information that is available by users.

18. The operation method of claim 17, wherein the receiving the source data from the payload and outputting the required data further comprises:
providing, by a weather satellite information service unit, the users with the produced general purpose information.
